(19) United States
(12) Patent Application Publication
(10) Pub. No.: US 2023/0380024 A1
(43) Pub. Date: Nov. 23, 2023

(54) INDUCTION HEATING APPARATUS AND CONTROL METHOD THEREOF

(71) Applicant: SAMSUNG ELECTRONICS CO., LTD., Suwon-si (KR)

(72) Inventors: Hongjoo KANG, Suwon-si (KR); Jungju KIM, Suwon-si (KR); Younghoon WOO, Suwon-si (KR); Jiwoong CHOI, Suwon-si (KR); Myoungjin HAM, Suwon-si (KR)

(21) Appl. No.: 18/123,067

(22) Filed: Mar. 17, 2023

Related U.S. Application Data
(63) Continuation of application No. PCT/KR2023/095008, filed on Feb. 24, 2023.

(30) Foreign Application Priority Data
May 19, 2022 (KR) 10-2022-0061693
Sep. 7, 2022 (KR) 10-2022-0113829

(51) Int. Cl. H05B 6/36; H05B 6/06

(52) U.S. Cl. CPC H05B 6/36; H05B 6/065; H05B 2213/03; H05B 2213/05

(57) ABSTRACT

An induction heating apparatus includes a plate on which a cookware is placed, a plurality of working coils disposed below the plate, a plurality of coil bases on which the plurality of working coils is disposed, and a cookware sensor. The plurality of coil bases are coupled to each other, and the cookware sensor is disposed between the plurality of working coils. A controller is configured to detect the presence or absence of the cookware on the plate based on a resonance signal generated by at least one of the plurality of working coils or the cookware sensor, and is configured to select a heating coil to be used for heating the cookware among the plurality of working coils.

### CROSS-REFERENCE TO RELATED APPLICATION(S)

This application is a continuation application, claiming priority under § 365(c), of International Application No. PCT/KR2023/095008, filed on Feb. 24, 2023, which is based on and claims the benefit of Korean patent application number 10-2022-0113829, filed on Sep. 7, 2022, in the Korean Intellectual Property Office and of Korean patent application number 10-2022-0061693, filed on May 19, 2022, in the Korean Intellectual Property Office, the disclosures of which are incorporated by reference herein in their entireties.

### BACKGROUND

### 1. Field

The disclosure relates to an induction heating apparatus configured to heat a cookware by an induction heating method and a control method thereof.

### 2. Description of Related Art

An induction heating apparatus is a cooking apparatus that uses magnetic induction to heat a cookware. The induction heating apparatus has more advantages in terms of stability, ease of use, and environmental protection in comparison with conventional gas ranges. Therefore, consumers are turning toward induction heating apparatuses to replace conventional gas cooking ranges.

An induction heating apparatus typically includes a plate on which a cookware is placed and a working coil provided under the plate. When electrical current is applied to the working coil and a magnetic field is generated, a secondary current is induced in the cookware placed on the plate, and Joule heat is generated by the resistance component of the cookware itself. When the induction heating apparatus operates, the cookware itself generates heat. The cookware formed of metallic iron, stainless steel or nickel may be used in the induction heating apparatus.

### SUMMARY

A non-limiting embodiment of the disclosure provides an induction heating apparatus capable of allowing multiple working coils to be easily arranged by modularizing a working coil and a coil base.

It is another aspect of the disclosure to provide an induction heating apparatus capable of minimizing an accommodation space of a cookware sensor by arranging the cookware sensor between a plurality of working coils.

It is another aspect of the disclosure to provide an induction heating apparatus capable of more accurately detecting a cookware by using a plurality of working coils and a cookware sensor and capable of easily selecting a working coil to be used for heating the cookware, and a control method thereof.

Additional aspects of the disclosure will be set forth in part in the description which follows and, in part, will be obvious from the description, or may be learned by practice of the disclosure.

In accordance with an aspect of the disclosure, an induction heating apparatus includes a plate on which a cookware is placed, a plurality of working coils disposed below the plate, a plurality of coil bases on which the plurality of working coils is disposed, the plurality of coil bases coupled to each other, a cookware sensor disposed between the plurality of working coils, and a controller configured to detect the presence or absence of the cookware on the plate based on a resonance signal generated by at least one of the plurality of working coils or the cookware sensor, and configured to select a heating coil to be used for heating the cookware among the plurality of working coils.

Each of the plurality of coil bases may include a base plate provided in a rectangular shape, a first coupler assembly protruding from a first side of the base plate and a second side of the base plate perpendicular to the first side, and a second coupler assembly protruding from a third side of the base plate facing the first side and a fourth side of the base plate facing the second side, the second coupler assembly configured to be vertically coupled to a first coupler assembly of another coil base.

The second coupler assembly may include an insertion hole provided to allow the first coupler assembly to be inserted thereinto, and a receiving groove provided to accommodate the cookware sensor.

The insertion hole of the second coupler assembly may include a first insertion hole arranged on one side of the receiving groove with respect to a longitudinal direction of the receiving groove, and a second insertion hole arranged on the other side of the receiving groove.

Two first couplers are formed on each of the first side and the second side of the base plate and spaced apart from each other at positions corresponding to the first insertion hole and the second insertion hole of the second coupler assembly with respect to a longitudinal direction of a side surface of the base plate.

The first coupler assembly may include a protrusion extending from a side surface of the base plate, and a fixer extending vertically from one end of the protrusion and formed to be fitted to the insertion hole of the second coupler.

The fixer may include a locking protrusion provided to prevent the fixer from being separated from the insertion hole.

A first height of the base plate may be greater than a second height of the protrusion of the first coupler assembly and a third height of the second coupler. A fourth height of the fixer may be greater than the third height of the second coupler.

The cookware sensor may include a ferrite core, a sensing coil wound around the ferrite core, and a sensing switch configured to switch application of a voltage to the sensing coil.

The controller may be configured to select two working coils, which are adjacent to the cookware sensor among the plurality of cooking coils, as the heating coil in response to the detection of the cookware by the cookware sensor.

The controller may be configured to detect the presence or absence of the cookware on the plate by using the plurality of working coils, based on the detection failure of the cookware by the cookware sensor. The controller may be configured to select a working coil, which detects the cookware among the plurality of working coils, as the heating coil.

In accordance with another aspect of the disclosure, a control method of an induction heating apparatus including a plurality of working coils and a cookware sensor arranged between the plurality of working coils, the control method includes detecting the presence or absence of the cookware on a plate based on a resonance signal generated by at least one of the plurality of working coils or the cookware sensor, and selecting a heating coil to be used for heating the cookware among the plurality of working coils, in response to the detection of the cookware.

The detection of the presence or absence of the cookware may include detecting the presence or absence of the cookware by firstly using the cookware sensor, and detecting the presence or absence of the cookware on the plate by using the plurality of working coils, based on the detection failure of the cookware by the cookware sensor.

The selection of the heating coil may include selecting two working coils, which are adjacent to the cookware sensor among the plurality of cooking coils, as the heating coil in response to the detection of the cookware by the cookware sensor.

The selection of the heating coil may include selecting a working coil, which detects the cookware among the plurality of working coils, as the heating coil.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 illustrates an external view of an induction heating apparatus according to an embodiment of the disclosure;

FIG. 2 illustrates a plurality of working coils and coil bases provided in a main body of the induction heating apparatus;

FIG. 3 illustrates the coil base according to an embodiment;

FIG. 4 illustrates an enlarged view of a receiving groove formed on a side surface of the coil base to accommodate a cookware sensor according to an embodiment;

FIG. 5 illustrates an enlarged view of a coupler of the coil base according to an embodiment;

FIG. 6 illustrates the cookware sensor according to an embodiment;

FIGS. 7 and 8 illustrate diagrams of a heating principle of the induction heating apparatus according to an embodiment;

FIG. 9 illustrates a block diagram of a control configuration of the induction heating apparatus according to an embodiment;

FIGS. 10 and 11 illustrate graphs of resonance signals generated by the cookware sensor or the working coil; and

FIG. 12 illustrates a flowchart of a control method of the induction heating apparatus according to an embodiment.

### DETAILED DESCRIPTION

Embodiments described in the disclosure and configurations shown in the drawings are merely examples of the embodiments of the disclosure, and may be modified in various different ways at the time of filing of the present application to replace the embodiments and drawings of the disclosure.

Also, the terms used herein are used to describe the embodiments and are not intended to limit and/or restrict the disclosure. The singular forms “a,” “an” and “the” are intended to include the plural forms as well, unless the context clearly indicates otherwise.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

In the following description, terms such as “unit”, “part”, “block”, “member”, and “module” indicate a unit for processing at least one function or operation. For example, those terms may refer to at least one process processed by at least one hardware such as Field Programmable Gate Array (FPGA), Application Specific Integrated Circuit (ASIC), at least one software stored in a memory or a processor.

It will be understood that, although the terms first, second, third, etc., may be used herein to describe various elements, but elements are not limited by these terms.

These terms are only used to distinguish one element from another element. For example, such terms do not limit the order and/or priority of the elements.

An identification code is used for the convenience of the description but is not intended to illustrate the order of each step. The each step may be implemented in the order different from the illustrated order unless the context clearly indicates otherwise.

In the disclosure disclosed herein, the expressions “at least one of ˜,” and the like used herein may include any and all combinations of one or more of the associated listed items. For example, the term “at least one of A, B or C” may refer to all combinations having A alone, B alone, C alone, A and B together, A and C together, B and C together, and/or A, B, and C together, etc.

The disclosure will be described more fully hereinafter with reference to the accompanying drawings.

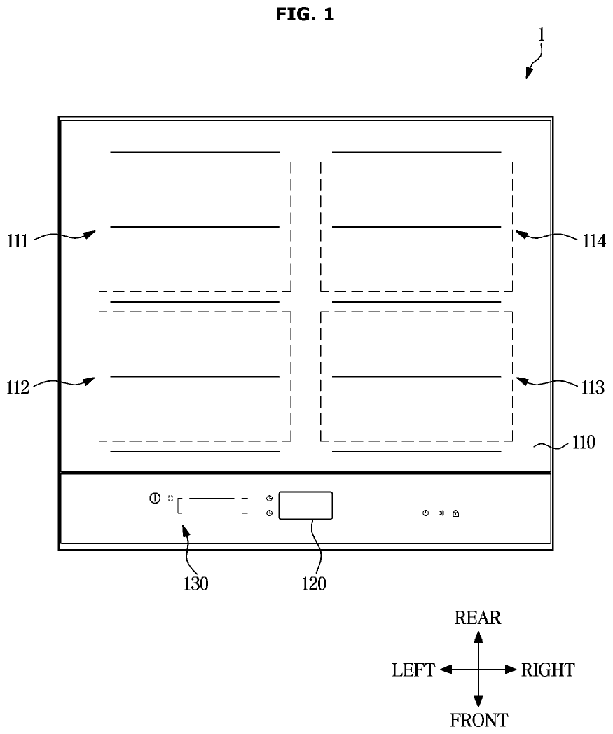

FIG. 1 illustrates an external view of an induction heating apparatus according to an embodiment of the disclosure.

FIG. 1 is a top plan view of an induction heating apparatus 1 according to an embodiment. The induction heating apparatus 1 includes a plate 110 provided on an upper portion of a main body, a plurality of cooking zones 111, 112, 113, and 114 formed on the plate 110, a display 120, and an input interface 130. Components of the induction heating apparatus 1 may be arranged within the main body. The plate 110 may be formed of a variety of materials. For example, the plate 110 may be formed of tempered glass such as ceramic glass.

The plurality of cooking zones 111, 112, 113, and 114 may indicate a position where a cookware can be placed. The plurality of cooking zones 111, 112, 113, and 114 may be divided by straight borders to guide proper placement of the cookware. For example, a first cooking zone 111, a second cooking zone 112, a third cooking zone 113, and a fourth cooking zone 114 may be provided. It is illustrated that four cooking zones are provided on the plate 110, but is not limited thereto. Four or more cooking zones may be provided according to a design thereof.

The display 120 and the input interface 130 may be provided in a region of the plate 110. For example, the display 120 and the input interface 130 may be provided in the front region of the plate 110 so as not to overlap the plurality of cooking zones 111, 112, 113, and 114. The positions of the display 120 and the input interface 130 are not limited thereto and may vary according to a design thereof.

The display 120 may display various information about a status and operation of the induction heating apparatus 1. The input interface 130 may obtain a user input related to the operation of the induction heating apparatus 1. The input interface 130 may include at least one of various input devices such as a touch button, a touch pad, a physical button or a dial. The display 120 and the input interface 130 may be provided as a touch screen.

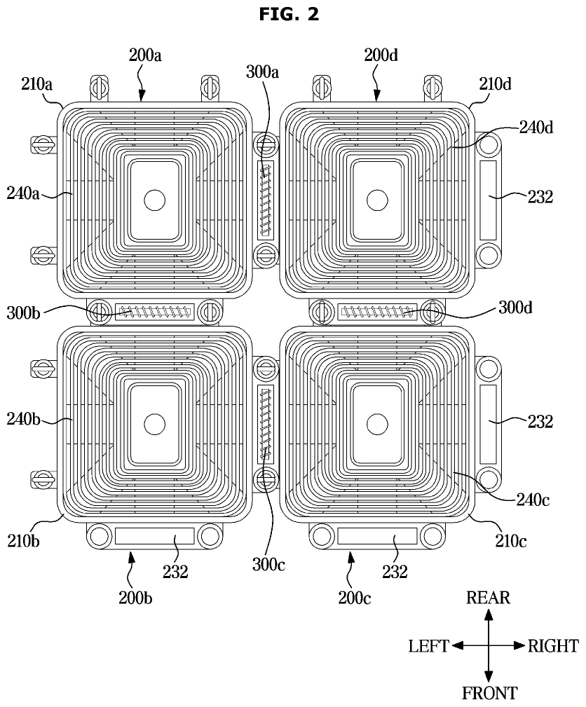

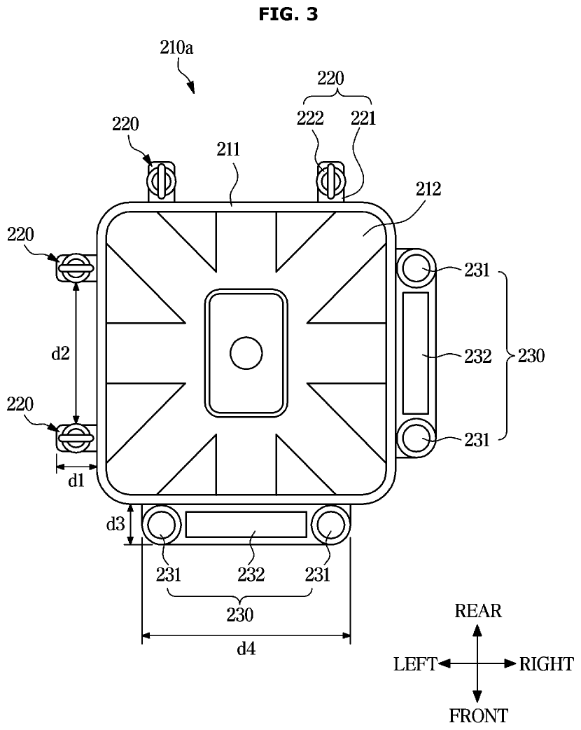

FIG. 2 illustrates a plurality of working coils and coil bases provided in a main body of the induction heating apparatus. FIG. 3 illustrates the coil base according to an embodiment.

Referring to FIG. 2, a plurality of coil modules 200a, 200b, 200c, and 200d may be disposed below the plate 110. For example, the plurality of coil modules 200a, 200b, 200c, and 200d may include a first coil module 200a, a second coil module 200b, a third coil module 200c, and a fourth coil module 200d. The number of coil modules is not limited thereto and may vary according to a design thereof.

Each of the plurality of coil modules 200a, 200b, 200c, and 200d may be disposed at a position corresponding to one of the plurality of cooking zones 111, 112, 113, and 114. The first coil module 200a may be disposed below the first cooking zone 111, the second coil module 200b may be disposed below the second cooking zone 112, the third coil module 200c may be disposed below the third cooking zone 113, and the fourth coil module 200d may be disposed below the fourth cooking zone 114.

Each of the plurality of coil modules 200a, 200b, 200c, and 200d includes a coil base and a working coil. For example, the first coil module 200a includes a first coil base 210a and a first working coil 240a. The second coil module 200b includes a second coil base 210b and a second working coil 240b. The third coil module 200c includes a third coil base 210c and a third working coil 240c. The fourth coil module 200d includes a fourth coil base 210d and a fourth working coil 240d.

A single working coil may be disposed on a single coil base. That is, the working coil is coupled to the coil base and supported by the coil base. Each of the plurality of working coils 240a, 240b, 240c, and 240d has a shape rolled into a spiral. Each of the plurality of working coils 240a, 240b, 240c, and 240d may have a shape corresponding to a shape of the coil base.

The plurality of coil modules 200a, 200b, 200c, and 200d may be coupled to each other. The plurality of coil modules 200a, 200b, 200c, and 200d may be coupled by a first coupler assembly and a second coupler assembly formed on the coil base. For example, the first coil module 200a may be coupled to the second coil module 200b and the fourth coil module 200d.

A cookware sensor 300 may be disposed between the plurality of working coils 240a, 240b, 240c, and 240d. The cookware sensor 300 may be disposed in a receiving groove 232 formed on a side surface of the coil base. The cookware sensor 300 may be provided in plurality. For example, a first cookware sensor 300a may be disposed between the first working coil 240a and the fourth working coil 240d, a second cookware sensor 300b may be disposed between the first working coil 240a and the second working coil 240b, a third cookware sensor 300c may be disposed between the second working coil 240b and the third working coil 240c, and a fourth cookware sensor 300d may be disposed between the third working coil 240c and the fourth working coil 240d. The number of cookware sensors is not limited thereto and may vary by a design thereof.

The first coil module 200a, the second coil module 200b, the third coil module 200c, and the fourth coil module 200d all have the same structure. Because the structure of the first coil module 200a is the same as that of other coil modules, only the structure of the first coil module 200a will be described for convenience of description. Further, for convenience of description, the first coil module 200a is referred to as a ‘coil module’, the first coil base 210a is referred to as a ‘coil base’, and the first working coil 240a is referred to as a ‘working coil’.

Referring to FIG. 3, the coil base 210 includes a base plate 211 provided in a rectangular shape. That is, the base plate 211 may include four side surfaces. The base plate 211 includes a supporter 212 provided to support the working coil 240a. The supporter 212 may be provided as a plate having a shape of an asterisk symbol (*) having a plurality of rods extending radially. The working coil 240a may be disposed on the base plate 211.

Although not shown, a ferrite rod (not shown) may be provided on a lower surface of the supporter 212. That is, the ferrite rod may be installed on a lower surface of each of the plurality of rods forming the supporter 212. The ferrite rods may also be arranged radially. The ferrite rod may be attached to the base plate 211 by an adhesive material. The ferrite rod is configured to increase a magnitude of the magnetic field generated by the working coil 240, and configured to prevent the magnetic force from being applied to components arranged below the coil module.

A first coupler assembly 220 and a second coupler assembly 230 may be formed on the side surface of the base plate 211. The first coupler assembly 220 may be formed on a first side and a second side of the base plate 211, respectively, and the second coupler assembly 230 may be formed on a third side and a fourth side of the base plate 211, respectively. As for the base plate 211, the first side is perpendicular to the second side, the third side is perpendicular to the fourth side, the first side faces the third side, and the second side faces the fourth side. In order words, the first side indicates the rear side, the second side indicates the left side, the third side indicates the front side, and the fourth side indicates the right side.

The first coupler assembly 220 may protrude to the outside of the base plate 211 from the first side and the second side of the base plate 211. The first coupler assembly 220 may protrude from the side surface of the base plate 211 by a first predetermined protrusion width d1.

The second coupler assembly 230 may protrude to the outside of the base plate 211 from the third side and the fourth side of the base plate 211. The second coupler assembly 230 may protrude from the side surface of the base plate 211 by a second predetermined protrusion width d2. The first protrusion width d1 may be the same as the second protrusion width d2. A length d4 of the second coupler assembly 230 may be less than a length of a side surface of the base plate 211.

A first coupler assembly 220 of one of the plurality of coil bases 210a, 210b, 210c, and 210d may be coupled to a second coupler assembly 230 of another of the plurality of coil bases 210a, 210b, 210c, and 210d. A second coupler assembly 230 of one coil base may be vertically coupled to a first coupler assembly 220 of another coil base.

For example, a second coupler assembly 230 formed on the right side of the first coil base 210a may be vertically coupled to a first coupler assembly 220 formed on the left side of the fourth coil base 210d. A second coupler assembly 230 formed on the front side of the first coil base 210a may be vertically coupled to a first coupler assembly 220 formed on the rear side of the second coil base 210b.

The second coupler assembly 230 includes an insertion hole 231 into which the first coupler assembly 220 is inserted, and the receiving groove 232 provided to accommodate the cookware sensor. A length of the receiving groove 232 is less than the length d4 of the second coupler assembly 230. The number of insertion holes 231 of the second coupler assembly 230 may be two. The two insertion holes 231 may be spaced apart from each other. The insertion hole 231 includes a first insertion hole arranged on one side of the receiving groove 232 with respect to a longitudinal direction of the receiving groove 232, and a second insertion hole arranged on the other side of the receiving groove 232 with respect to the longitudinal direction of the receiving groove 232.

The first coupler assembly 220 includes a protrusion 221 extending from the side surface of the base plate 211 and a fixer 222 extending vertically from one end of the protrusion 221. The fixer 222 extends upward from the protrusion 221. Therefore, the first coupler assembly 220 may have an L-pin shape.

The fixer 222 may be provided in a cylindrical shape. The fixer 222 may be fitted to the insertion hole 231 of the second coupler assembly 230. The fixer 222 may include a locking protrusion provided to prevent the fixer 222 from being separated from the insertion hole 231. When the fixer 222 is fitted to the insertion hole 231, the locking protrusion comes out upward from the insertion hole 231 and is caught on an upper surface of the second coupler assembly 230.

The first coupler assembly 220 and the second coupler assembly 230 may be coupled in a male-female manner. The first coupler assembly 220 may be referred to as a ‘male coupler’, and the second coupler assembly 230 may be referred to as a ‘female coupler’.

The first coupler assembly 220 may be provided in plurality. For example, two first couplers 220 may be formed on each of the first side and the second side of the base plate 211. The two first couplers 220 are spaced apart along the longitudinal direction of the side surface of the base plate 211. On one side surface of the base plate 211, the two first couplers 220 may be formed to have a predetermined separation distance d2.

The two first couplers 220 are formed at a position corresponding to the first insertion hole and the second insertion hole of the second coupler assembly 230 located on the opposite side. The first coupler assembly 220 arranged on the rear left side of the base plate 211 and the insertion hole 231 arranged on the front left side of the base plate 211 are located on the same straight line. The first coupler assembly 220 arranged on the rear right side of the base plate 211 and the insertion hole 231 arranged on the front right side of the base plate 211 are located on the same straight line. Further, the first coupler assembly 220 arranged on the upper left side of the base plate 211 and the insertion hole 231 arranged on the upper right side of the base plate 211 are located on the same straight line. The first coupler assembly 220 arranged on the lower left side of the base plate 211 and the insertion hole 231 arranged on the lower right side of the base plate 211 are located on the same straight line.

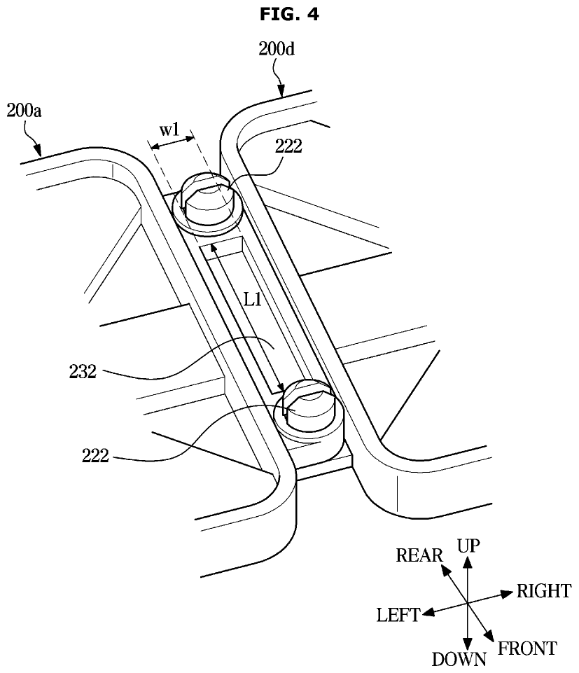

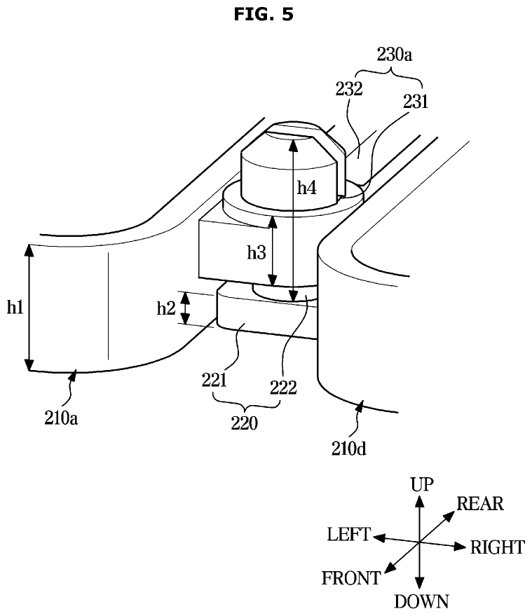

FIG. 4 illustrates an enlarged view of a receiving groove formed on a side surface of the coil base to accommodate a cookware sensor according to an embodiment. FIG. 5 illustrates an enlarged view of a coupler of the coil base according to an embodiment.

Referring to FIG. 4, the first coil module 200a is coupled to the fourth coil module 200d. As the second coupler assembly 230 formed on the right side of the first coil base 210a is vertically coupled to the first coupler assembly 220 formed on the left side of the fourth coil base 210d, the first coil module 200a is coupled to the fourth coil module 200d. Particularly, the fixer 222 of the first coupler assembly 220 on the left side of the fourth coil base 210d is inserted into the insertion hole 231 formed in the second coupler assembly 230 on the right side of the first coil base 210a.

In a state in which the first coil base 210a is coupled to the fourth coil base 210d, the receiving groove 232 on the right side of the first coil base 210a is positioned between two first couplers 220 formed on the left side of the fourth coil base 210d. A width W1 of the receiving groove 232 formed in the second coupler assembly 230 of the first coil base 210a is less than the protrusion width d3 of the second coupler assembly 230, and a length L1 of the receiving groove 232 is less than the length d4 of the second coupler assembly 230.

FIG. 5 is an enlarged view illustrating a state in which the second coupler assembly 230 of the first coil base 210a is coupled to the first coupler assembly 220 of the fourth coil base 210d. A first height h1 of the base plate 211 is greater than a second height h2 of the protrusion 221 of the first coupler assembly 220, and a third height h3 of the second coupler assembly 230. A fourth height h4 of the fixer 222 is greater than the third height h3 of the second coupler assembly 230. The height of the base plate 211, the protrusion 221 and the second coupler assembly 230 may represent a thickness of the base plate 211, the protrusion 221 and the second coupler assembly 230. A depth of the receiving groove 232 is less than the third height h3 of the second coupler assembly 230.

With respect to the side surface of the base plate 211, the second coupler assembly 230 is located above the protrusion 221 of the first coupler assembly 220. As the fixer 222 of the first coupler assembly 220 is fitted to the insertion hole 231 of the second coupler assembly 230, the first coupler assembly 220 is vertically coupled to the second coupler assembly 230. When the fixer 222 is fitted to the insertion hole 231, the protrusion comes out upward from the insertion hole 231 and is caught on the upper surface of the second coupler assembly 230. Therefore, the state, in which the first coupler assembly 220 is coupled to the second coupler assembly 230, may be maintained.

The coupling between the first coupler assembly 220 and the second coupler assembly 230 may be released by external pressure. For example, the fixer 222 may have elasticity. When pressure is applied to an upper end of the fixer 222 in the front and rear direction, a diameter of the upper end of the fixer 222 is reduced and then less than a diameter of the insertion hole 231 of the second coupler assembly 230. When a pushing force acts downward in a state in which pressure is applied to the upper end of the fixer 222 in the front and rear direction, the fixer 222 may come out of the insertion hole 231.

As mentioned above, because the first coupler assembly 220 and the second coupler assembly 230 are easily coupled to each other or easily separated from each other, it is possible to easily assemble the plurality of coil modules 200a, 200b, 200c, and 200d.

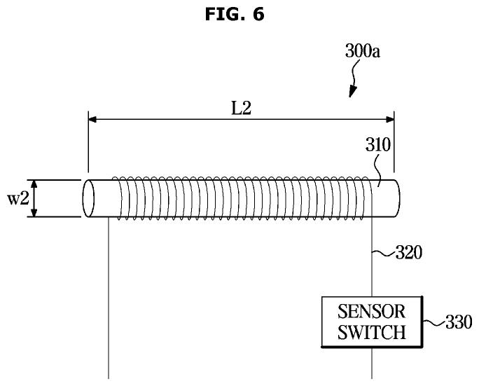

FIG. 6 illustrates the cookware sensor according to an embodiment.

As shown in FIG. 2, each of the plurality of cookware sensors 300a, 300b, 300c, and 300d may be disposed between the plurality of working coils 240a, 240b, 240c, and 240d. The first cookware sensor 300a, the second cookware sensor 300b, the third cookware sensor 300c, and the fourth cookware sensor 300d all have the same structure, but a length of each cookware sensor may vary according to a position thereof. A structure of the first cookware sensor 300a is the same as that of other cookware sensors, and thus only the structure of the first cookware sensor 300a will be described for convenience of description.

Referring to FIG. 6, the cookware sensor 300a may include a ferrite core 310, a sensing coil 320 wound around the ferrite core 310, and a sensing switch 330 configured to switch application of voltage to the sensing coil 320.

The ferrite core 310 may be provided in a rod shape or a cylindrical shape. The shape of the ferrite core 310 is not limited thereto, and may have various shapes capable of being inserted into the receiving groove 232 formed in the coil base. Ferrite is a metal in a body centered cubic lattice and is a ferromagnetic substance. Because the ferrite core 310 has a shape corresponding to the receiving groove 232 formed in the coil base, a length L2 of the ferrite core 310 may be greater than a width W2. The length L2 of the ferrite core 310 is less than the length L1 of the receiving groove 232, and the width W2 of the ferrite core 310 is less than the width W1 of the receiving groove 232.

The cookware sensor 300 including the ferrite core 310 is located between the plurality of working coils 240a, 240b, 240c, and 240d, and thus a magnetic field generated by the working coil does not affect other working coils. In other words, the cookware sensor 300 may shield the magnetic field generated by the working coil. That is, it is possible to prevent frequency interference between adjacent working coils. The magnetic field generated by each of the plurality of working coils 240a, 240b, 240c, and 240d may not affect other working coils. Accordingly, the independence of working coils may be improved, and the control accuracy may be improved.

The sensing coil 320 may be wound around the ferrite core 310. The sensing coil 320 may be wound around an outer surface of the ferrite core 310 by a predetermined number of rotations. The sensing coil 320 may be drawn out from each of both ends of the ferrite core 310. The sensing switch 330 may be connected to one end of the sensing coil 320. The cookware sensor 300 may generate a resonance signal according to the repeated on-off operation of the sensing switch 330.

The sensing switch 330 may periodically and repeatedly turned on and off under the control of a controller 430 to be described later. The controller 430 may detect a resonance signal generated by the cookware sensor 300. The controller 430 may detect the presence or absence of a cookware on the plate 110 based on the resonance signal of the cookware sensor 300.

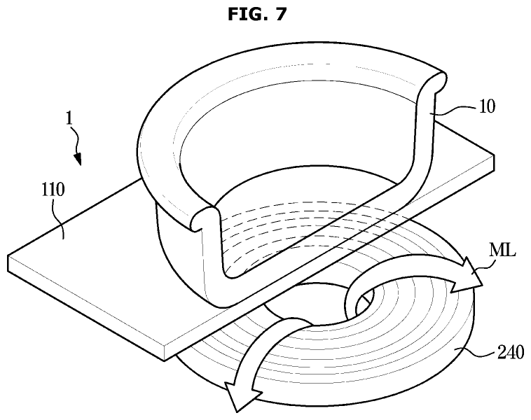

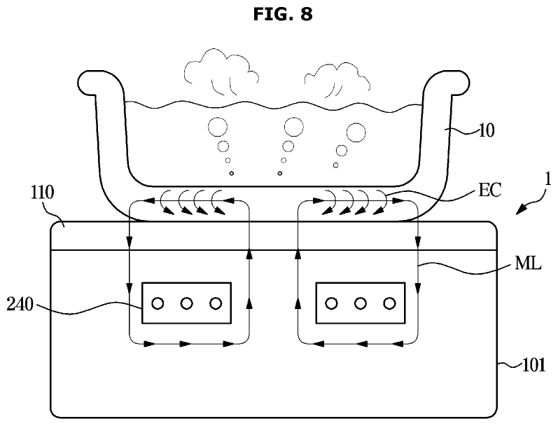

FIGS. 7 and 8 illustrate diagrams of a heating principle of the induction heating apparatus according to an embodiment.

Referring to FIGS. 7 and 8, the working coil 240 is disposed in the main body 101 of the induction heating apparatus 1, and located under the plate 110. A high frequency electrical current may be applied to the working coil 240. For example, the frequency of the high frequency current may be 20 kHz to 35 kHz. When a high frequency current is applied to the working coil 240, magnetic lines of force ML may be formed in the working coil 240.

When a cookware 10 having a resistance is located within a range of the magnetic line of force ML, the magnetic lines of force ML around the working coil 240 pass through the bottom of the cookware 10 and generate an induced electrical current in the form of a vortex, that is, an eddy current EC according to the law of electromagnetic induction. Heat may be generated in the cookware 10 by the interaction between the eddy current EC and the electrical resistance of the cookware 10, and a cooking material inside the cookware 10 may be heated by the generated heat. That is, the cookware 10 itself serves as a heat source. The cookware 10 formed of iron, stainless steel or nickel having a certain level of resistance may be used in the induction heating apparatus 1.

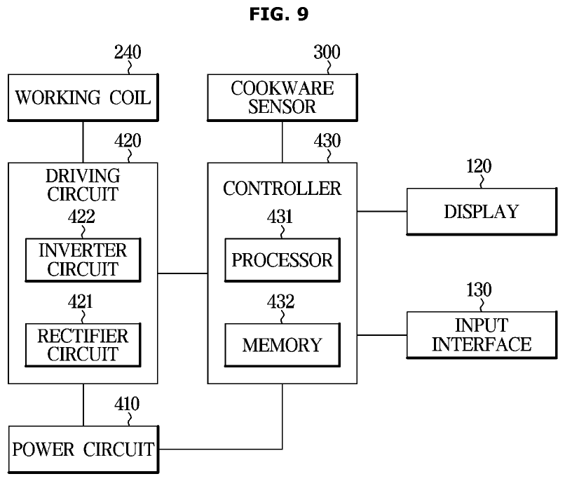

FIG. 9 illustrates a block diagram of a control configuration of the induction heating apparatus according to an embodiment.

Referring to FIG. 9, the induction heating apparatus 1 may include the display 120, the input interface 130, the working coil 240, the cookware sensor 300, a power circuit 410, a driving circuit 420 and the controller 430.

The controller 430 may be electrically connected to the components of the induction heating apparatus 1 and may control the operation of each component. The controller 430 may include a control circuit. A printed circuit board may be provided in the main body 101. The electronic components of the induction heating apparatus 1 may be installed on one printed circuit board or divided and installed on a plurality of printed circuit boards.

The display 120 may display information, which is input by a user, or information, which is provided to a user, on various screens. The display 120 may include a liquid crystal display (LCD) panel, a light emitting diode (LED) panel, an organic light emitting diode (OLED) panel, or a micro-LED panel.

The input interface 130 may obtain a user input related to the operation of the induction heating apparatus 1. For example, the input interface 130 may include various buttons such as a power button, a cooking zone setting button, a temperature setting button and/or a timer button. The input interface 130 may include at least one of various input devices such as a touch button, a touch pad, a physical button, and a dial. The display 120 and the input interface 130 may be provided as a touch screen.

The working coil 240 may generate a magnetic field and/or an electromagnetic field based on a current applied from the driving circuit 420. Due to the magnetic field generated by the working coil 240, the cookware 10 positioned on the plate 110 may be heated. As mentioned above, the working coil 240 may be provided in plurality.

The cookware sensor 300 may be used to detect the cookware 10 positioned on the plate 110. The controller 430 may apply a current to the sensing coil 320 of the cookware sensor 300, and may periodically control the on-off operation of the sensing switch 330. The controller 430 may detect the presence or absence of the cookware on the plate 110 based on the resonance signal generated by the cookware sensor 300, and select a heating coil, which is to be used for heating the cookware 10, from among the plurality of working coils.

The power circuit 410 may be connected to an external power source, and obtain power, which needs for the operation of the induction heating apparatus 1, from the external power source. The power circuit 410 may be connected to the driving circuit 420, and supply power to the driving circuit 420. Further, the power circuit 410 may be connected to the controller 430, and supply power to the controller 430.

The drive circuit 420 may receive power from the power circuit 410 and rectify the power, thereby supplying the rectified power to the working coil 240. The driving circuit 420 may include a rectifier circuit 421 and an inverter circuit 422. The rectifier circuit 421 may convert AC power into DC power. The rectifier circuit 421 may be configured to convert an AC voltage, in which a magnitude and polarity thereof (positive voltage or negative voltage) change with time, into a DC voltage with a constant magnitude and polarity, and configured to convert an AC current, in which a magnitude and polarity thereof (positive current or negative current) change with time, into a DC current with a constant magnitude.

The rectifier circuit 421 may include a bridge diode. For example, the rectifier circuit 421 may include four diodes. The diodes form a series-connected pair of two diodes, and the two diode pairs may be connected in parallel with each other. The bridge diode may convert an AC voltage, in which a polarity changes over time, into a positive voltage with a constant polarity, and convert an AC current, in which a direction thereof changes over time, into a positive current with a constant direction.

In addition, the rectifier circuit 421 may include a direct current (DC) link capacitor. The DC link capacitor may convert a positive voltage, in which a magnitude thereof changes over time, into a DC voltage with a constant magnitude. The DC link capacitor may maintain the DC voltage and provide the DC voltage to the inverter circuit 422.

The inverter circuit 422 may switch a voltage applied to the working coil 240 so as to allow electrical current to flow in the working coil 240. The inverter circuit 422 may include a switching circuit configured to supply or block a current to the working coil 240 and a resonant capacitor. The switching circuit may include at least one switching device. One end of the working coil 210 may be connected to a connection point of the switching device, and the other end of the working coil 210 may be connected to the resonant capacitor. The resonance capacitor acts as a buffer. The resonant capacitor affects the energy loss by controlling a rise rate of a saturation voltage while the switching device is turned off.

The switching device may be turned on or off according to a control signal generated by the controller 430. A current and voltage may be applied to the working coil 240 due to the switching operation (on-off) of the switching device. A resonant frequency of the working coil 240 may be determined by a switching speed of the switching device. Further, the resonant capacitor may also affect the resonant frequency of the working coil 240.

Because the switching device is turned on or off at high speed, the switching device may be implemented as a three terminal semiconductor switching device with fast response speed. For example, the switching device may be a bipolar junction transistor (BJT), a metal-oxide-semiconductor field effect transistor (MOSFET), an insulated gate bipolar transistor (IGBT), or a thyristor.

The controller 430 may include a processor 431 and a memory 432. The memory 432 may store programs, instructions and data for controlling the operation of the induction heating apparatus 1. The processor 431 may generate a control signal for controlling the operation of the induction heating apparatus 1 based on programs, instructions, and data stored and/or stored in the memory 432. The controller 430 may be implemented as a control circuit in which the processor 431 and the memory 432 are mounted. In addition, the controller 430 may include a plurality of processors and a plurality of memories.

The processor 431 is hardware and may include a logic circuit and an arithmetic circuit. The processor 431 may process data according to a program and/or instructions provided from the memory 432 and may generate a control signal according to a processing result. The memory 432 may include a volatile memory such as Static Random Access Memory (SRAM) or Dynamic Random Access Memory (DRAM) for temporarily storing data, and a non-volatile memory such as Read Only Memory (ROM), Erasable Programmable Read Only Memory (EPROM) or Electrically Erasable Programmable Read Only Memory (EEPROM) for long-term storage of data.

In response to the detection of the cookware 10 by the cookware sensor 300, the controller 430 may select two working coils, which are adject to the cookware sensor 300 among the plurality of working coils, as a heating coil. For example, when the cookware 10 is detected by the first cookware sensor 300a arranged between the first working coil 240a and the fourth working coil 240d, the controller 430 may determine to drive the first working coil 240a and the fourth working coil 240d adjacent to the first cookware sensor 300a. As another example, when the cookware 10 is detected by the second cookware sensor 300b arranged between the first working coil 240a and the second working coil 240b, the controller 430 may determine to drive the first working coil 240a and the second working coil 240b adjacent to the second cookware sensor 300b.

Further, the controller 430 may detect the cookware 10 positioned on the plate 110 by using the working coil 240. Based on the detection failure of the cookware 10 by the cookware sensor 300, the controller 430 may detect the presence or absence of the cookware 10 on the plate 110 by using the plurality of working coils. The controller 430 may select the working coil 240, which detects the cookware 10 among the plurality of working coils, as a heating coil.

When the cookware 10 having a size less than an area of the working coil 240 is placed in a position corresponding to the center of the working coil 240, the cookware sensor 300 may fail to detect the cookware 10. That is, the cookware sensor 300 is located near an edge of the working coil 240, and thus when an area of the bottom of the cookware 10 placed in the center of the working coil 240 is less than the area of the working coil 240, the cookware sensor 300 may not detect the cookware 10. When this scenario occurs, it is still possible to detect the cookware 10 based on a resonance signal generated by the working coil 240.

For example, the cookware 10 having a relatively small size may be placed on the first working coil 240a. The controller 430 may identify that the cookware 10 is placed on the first working coil 240a based on the resonance signal generated by the first working coil 240a, and then the controller 430 may determine to drive the first working coil 240a. That is, the first working coil 240a may be selected as a heating coil for heating the cookware 10.

A magnitude of electrical current applied to the working coil 240 to detect the cookware 10 may be less than a magnitude of a current applied to the working coil 240 to heat the cookware 10. Further, a resonant frequency of the working coil 240 to detect the cookware 10 may be less than a resonant frequency of the working coil 240 to heat the cookware 10.

As mentioned above, by using at least one of the cookware sensor 300 and the working coil 240, the disclosed induction heating apparatus 1 may easily detect the cookware 10 having a relatively small area as well as the cookware 10 having a relatively large area.

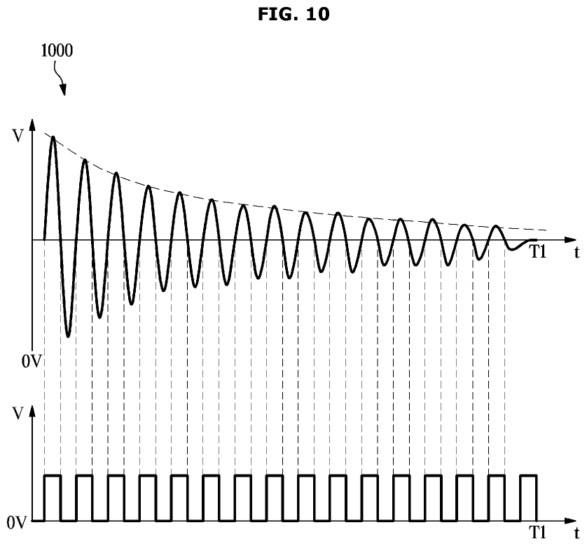

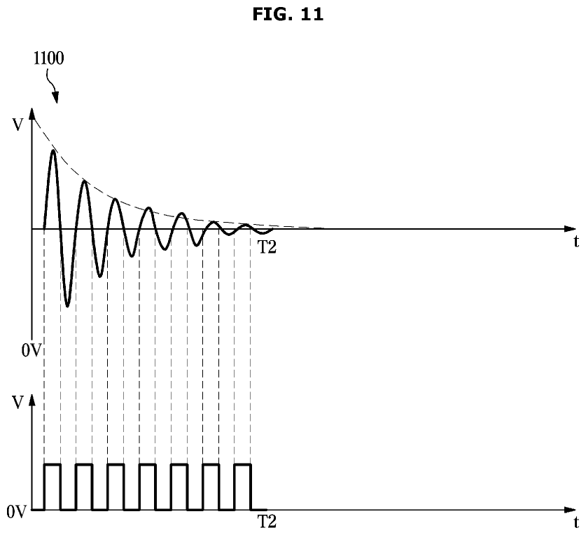

FIGS. 10 and 11 illustrate graphs of resonance signals generated by the cookware sensor or the working coil.

As mentioned above, the working coil 240 may resonate by the on-off operation of the switching circuit included in the inverter circuit 422, and the cookware sensor 300 may resonate by the on-off operation of the sensing switch 330. The resonance signal generated by the cookware sensor 300 and/or the resonance signal generated by the working coil 240 may be represented as a voltage graph. The resonance signal decays and disappears over time.

Referring to a graph 1000 of FIG. 10, it is confirmed that a decay rate of the resonance signal is relatively slow when the cookware 10 is not present on the working coil 240 or the cookware sensor 300. On the other hand, referring to a graph 1100 of FIG. 11, it is confirmed that a decay rate of the resonance signal rapidly decays and disappears when the cookware 10 is located on the working coil 240.

The controller 430 may detect the decay rate of the resonance signal generated by the working coil 240 or the cookware sensor 300. The controller 430 may determine that the cookware 10 is present on the plate 110 when the decay rate of the resonance signal is fast (e.g., exceeds a rate threshold).

The resonance signal may be detected in the form of a pulse signal. The controller 430 may count pulses or count a duration of pulses during a given time period. The controller 430 may compare the counted number or duration of pulses with a reference value (e.g., a threshold) to determine the presence or absence of the cookware 10. For example, the controller 430 may determine that the cookware 10 is located on the plate 110 in response to the counted number or duration of pulses being less than a predetermined reference value. On the contrary, the controller 430 may determine that the cookware 10 is not located on the plate 110 in response to the counted number or duration of pulses being greater than or equal to the reference value.

Alternatively, the controller 430 may detect the presence or absence of the cookware 10 on the plate 110 based on an output voltage or output current of each of the cookware sensor 300 and the working coil 240. For example, the controller 430 may determine that the cookware 10 is located on the plate 110 in response to the output voltage of each of the cookware sensor 300 and the working coil 240 being less than a predetermined reference voltage. The controller 430 may determine that the cookware 10 is located on the plate 110 in response to the output current of each of the cookware sensor 300 and the working coil 240 being less than a predetermined reference current.

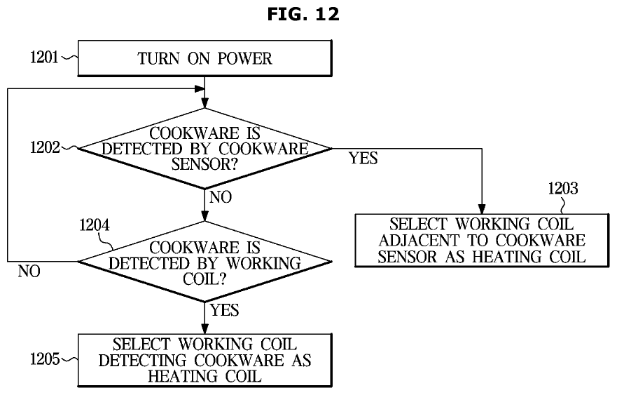

FIG. 12 illustrates a flowchart of a control method of the induction heating apparatus according to an embodiment.

Referring to FIG. 12, in response to the power of the induction heating apparatus 1 being turned on (1201), the controller 430 may detect the presence or absence of the cookware 10 on the plate 110 by using the cookware sensor 300 (1202). The controller 430 may detect the presence or absence of the cookware 10 based on the resonance signal generated by the cookware sensor 300. In response to detection of the cookware 10 by the cookware sensor 300, the controller 430 may select two working coils, which are adjacent to the cookware sensor 300 among the plurality of working coils, as a heating coil (1203).

Based on the detection failure of the cookware 10 by the cookware sensor 300, the controller 430 may detect the presence or absence of the cookware 10 on the plate 110 by using the plurality of working coils (1204). The controller 430 may select the working coil 240, which detects the cookware 10 among the plurality of working coils, as a heating coil (1205).

As is apparent from the above description, an induction heating apparatus may allow multiple working coils to be easily arranged by modularizing a working coil and a coil base. An induction heating apparatus may minimize an accommodation space of a cookware sensor by placing the cookware sensor to between a plurality of working coils. An induction heating apparatus and a control method thereof may more accurately detect a cookware by using a plurality of working coils and a cookware sensor, and may easily select a working coil to be used for heating the cookware.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments.

Storage medium readable by machine, may be provided in the form of a non-transitory storage medium. “Non-transitory” means that the storage medium is a tangible device and does not contain a signal (e.g., electromagnetic wave), and this term includes a case in which data is semi-permanently stored in a storage medium and a case in which data is temporarily stored in a storage medium. For example, ‘non-transitory storage medium’ may include a buffer in which data is temporally stored.

The method according to the various disclosed embodiments may be provided by being included in a computer program product. Computer program products may be traded between sellers and buyers as commodities. Computer program products are distributed in the form of a device-readable storage medium (e.g., compact disc read only memory (CD-ROM)), or are distributed directly or online (e.g., downloaded or uploaded) between two user devices (e.g., smartphones) through an application store (e.g., Play Store™). In the case of online distribution, at least a portion of the computer program product (e.g., downloadable app) may be temporarily stored or created temporarily in a device-readable storage medium such as the manufacturer's server, the application store's server, or the relay server's memory.

Although a few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. An induction heating apparatus comprising:
a plate on which a cookware is placed;
a plurality of working coils disposed below the plate;
a plurality of coil bases on which the plurality of working coils is disposed, the plurality of coil bases coupled to each other;
a cookware sensor disposed between the plurality of working coils; and
a controller configured to detect a presence or an absence of the cookware on the plate based on a resonance signal generated by at least one of the plurality of working coils or the cookware sensor, and configured to select a heating coil to be used for heating the cookware among the plurality of working coils.

2. The induction heating apparatus of claim 1, wherein
each of the plurality of coil bases comprises:
a base plate provided in a rectangular shape;
a first coupler assembly protruding from a first side of the base plate and a second side of the base plate perpendicular to the first side; and
a second coupler assembly protruding from a third side of the base plate facing the first side, and a fourth side of the base plate facing the second side, the second coupler assembly configured to be vertically coupled to a first coupler assembly of another coil base.

3. The induction heating apparatus of claim 2, wherein
the second coupler assembly comprises:
an insertion hole provided to allow the first coupler assembly to be inserted thereinto; and
a receiving groove provided to accommodate the cookware sensor.

4. The induction heating apparatus of claim 3, wherein
the insertion hole of the second coupler assembly comprises:
a first insertion hole arranged on one side of the receiving groove with respect to a longitudinal direction of the receiving groove; and
a second insertion hole arranged on the other side of the receiving groove.

5. The induction heating apparatus of claim 4, wherein
two first couplers are formed on each of the first side and the second side of the base plate,
wherein the two first couplers are spaced apart from each other at positions corresponding to the first insertion hole and the second insertion hole of the second coupler assembly with respect to a longitudinal direction of a side surface of the base plate.

6. The induction heating apparatus of claim 3, wherein
the first coupler assembly comprises:
a protrusion extending from a side surface of the base plate; and
a fixer extending vertically from one end of the protrusion, and formed to be fitted to the insertion hole of the second coupler.

7. The induction heating apparatus of claim 6, wherein
the fixer comprises a locking protrusion provided to prevent the fixer from being separated from the insertion hole.

8. The induction heating apparatus of claim 6, wherein
a first height of the base plate is greater than a second height of the protrusion of the first coupler assembly and a third height of the second coupler,
wherein a fourth height of the fixer is greater than the third height of the second coupler.

9. The induction heating apparatus of claim 2, wherein
the cookware sensor comprises:
a ferrite core;
a sensing coil wound around the ferrite core; and
a sensing switch configured to switch application of a voltage to the sensing coil.

10. The induction heating apparatus of claim 1, wherein
the controller is configured to select two working coils, which are adjacent to the cookware sensor among the plurality of working coils, as the heating coil in response to the detection of the cookware by the cookware sensor.

11. The induction heating apparatus of claim 10, wherein
the controller is configured to detect the presence or the absence of the cookware on the plate by using the plurality of working coils, based on the detection failure of the cookware by the cookware sensor,
wherein the controller is configured to select a working coil, which detects the cookware among the plurality of working coils, as the heating coil.

12. A control method of an induction heating apparatus comprising a plurality of working coils and a cookware sensor arranged between the plurality of working coils, the control method comprising:
detecting the presence or the absence of the cookware on a plate based on a resonance signal generated by at least one of the plurality of working coils or the cookware sensor; and
selecting a heating coil to be used for heating the cookware among the plurality of working coils, in response to the detection of the cookware.

13. The control method of claim 12, wherein
the detection of the presence or absence of the cookware comprises:
detecting the presence or the absence of the cookware by firstly using the cookware sensor; and
detecting the presence or the absence of the cookware on the plate by using the plurality of working coils, based on the detection failure of the cookware by the cookware sensor.

14. The control method of claim 13, wherein:
the selection of the heating coil comprises selecting two working coils, which are adjacent to the cookware sensor among the plurality of working coils, as the heating coil in response to the detection of the cookware by the cookware sensor.

15. The control method of claim 13, wherein
the selection of the heating coil comprises selecting a working coil, which detects the cookware among the plurality of working coils, as the heating coil.
